(19) United States
(12) Patent Application Publication
(10) Pub. No.: US 2026/0010484 A1
(43) Pub. Date: Jan. 8, 2026

(54) SYSTEM-ON-CHIP AND OPERATING METHOD THEREOF

(71) Applicant: SAMSUNG ELECTRONICS CO., LTD., Suwon-si (KR)

(72) Inventors: Moongyung KIM, Suwon-si (KR); Euiyeon WON, Suwon-si (KR); Youngsik EOM, Suwon-si (KR)

(73) Assignee: SAMSUNG ELECTRONICS CO., LTD., Suwon-si (KR)

(21) Appl. No.: 19/048,403

(22) Filed: Feb. 7, 2025

(30) Foreign Application Priority Data
Jul. 4, 2024 (KR) 10-2024-0088502

(51) Int. Cl. G06F 12/1027; G06F 12/1009; G06F 15/78

(52) U.S. Cl. CPC G06F 12/1027; G06F 12/1009; G06F 15/7807

(57) ABSTRACT

A system-on-chip includes a translation lookaside buffer (TLB) that stores a portion of address translation information for translating between virtual addresses and physical addresses, a core that executes an instruction and accesses the TLB, a page table walker that performs a page table walk operation of searching a page table that stores the address translation information, and a static page management (SPM) circuit that, when a physical address is obtained from a virtual address included in static address translation information corresponding to a static page among the address translation information, stops access to the TLB by the core or stops the page table walk operation.

### CROSS-REFERENCE TO RELATED APPLICATION

This application is based on and claims priority under 35 U.S.C. § 119 to Korean Patent Application No. 10-2024-0088502, filed on Jul. 4, 2024, in the Korean Intellectual Property Office, the disclosure of which being incorporated by reference herein in its entirety.

### BACKGROUND

Apparatuses, devices, and methods consistent with the present disclosure relate to a system-on-chip, and more particularly, to a system-on-chip managing a static page and an operating method thereof.

A system-on-chip (SoC) is an integrated circuit in which a plurality of components or a plurality of intellectual properties (IPs) of an electronic system are integrated. A processor of the SoC may execute a plurality of application programs desired by a user and, for this purpose, may exchange data with a memory device. However, because the user may want to rapidly and simultaneously execute the plurality of application programs, the processor may be required to efficiently use the limited resources of the memory device.

### SUMMARY

It is an aspect to provide a system-on-chip and an operating method thereof for improving an access speed with respect to a static page.

According to an aspect of one or more embodiments, there is provided a system-on-chip comprising a translation lookaside buffer (TLB) that stores a portion of address translation information for translating between virtual addresses and physical addresses; at least one core configured to execute an instruction and to access the TLB; a page table walker configured to perform a page table walk operation of searching a page table that stores the address translation information; and a static page management (SPM) circuit configured to, when a physical address is obtained from a virtual address included in static address translation information corresponding to a static page among the address translation information, stop access to the TLB by the at least one core or stop the page table walk operation.

According to another aspect of one or more embodiments, there is provided an operating method of a system-on-chip, the operating method comprising starting a first search operation of searching a translation lookaside buffer (TLB) that stores address translation information corresponding to a static page and a dynamic page, the address translation information being for translating between virtual addresses and physical addresses; starting a second search operation of searching a static page management buffer that stores static address translation information corresponding to the static page; and obtaining a physical address corresponding to a virtual address, based on a result of the first search operation or a result of the second search operation. In response to the result of the second search operation being received while the first search operation is still being performed, stopping the first search operation.

According to yet another aspect of one or more embodiments, there is provided an operating method of a system-on-chip, the operating method comprising performing a first search operation of searching a translation lookaside buffer (TLB) that stores address translation information for a dynamic page and a static page, the address translation information being for translating between virtual addresses and physical addresses; performing a second search operation of searching a page table that is stored in a memory device, based on a result of the first search operation; and replacing address translation information for the dynamic page in preference to replacing address translation information for the static page, in at least one of the TLB and the page table, based on the result of the first search operation and a result of the second search operation.

### BRIEF DESCRIPTION OF THE DRAWINGS

Various embodiments will be more clearly understood from the following detailed description taken in conjunction with the accompanying drawings, in which:

FIG. 1 is a block diagram illustrating an electronic apparatus according to an embodiment;

FIG. 2 illustrates a block diagram of one of first to fourth cores of a system-on-chip (SoC) of the electronic apparatus of FIG. 1 and a memory management unit (MMU) corresponding thereto, according to some embodiments;

FIG. 3 illustrates application programs and an operating system (OS) executed by the SoC and main memory of the electronic apparatus of FIG. 1, according to some embodiments;

FIG. 4 illustrates a mapping between a virtual address space and a physical address space of the application programs of FIG. 3, according to an embodiment;

FIG. 5 illustrates a page table walk operation of a page table walker of the MMU of FIG. 2, according to some embodiments;

FIG. 6 is a diagram illustrating a translation lookaside buffer (TLB) and a static page management buffer (SPMB), according to some embodiments;

FIG. 7 is a diagram illustrating a TLB according to an embodiment;

FIG. 8 is a diagram illustrating an operation of an electronic apparatus according to an embodiment;

FIG. 9 is a flowchart illustrating an operating method of an SoC, according to an embodiment;

FIG. 10 is a flowchart illustrating an operating method of an SoC, according to an embodiment; and

FIG. 11 is a flowchart illustrating an operating method of an SoC, according to an embodiment.

### DETAILED DESCRIPTION

In the system-on-chip (SoC) described above, the processor may use a virtual memory space and manage a page table including mapping information between the virtual memory space and a physical memory space of the memory device. The processor may search the page table to perform translation between a virtual address and a physical address. The processor may store mapping information of a frequently-accessed virtual address in a translation lookaside buffer (TLB). The processor may shorten the address translation time by searching the TLB.

Hereinafter, various embodiments will be described in detail with reference to the accompanying drawings.

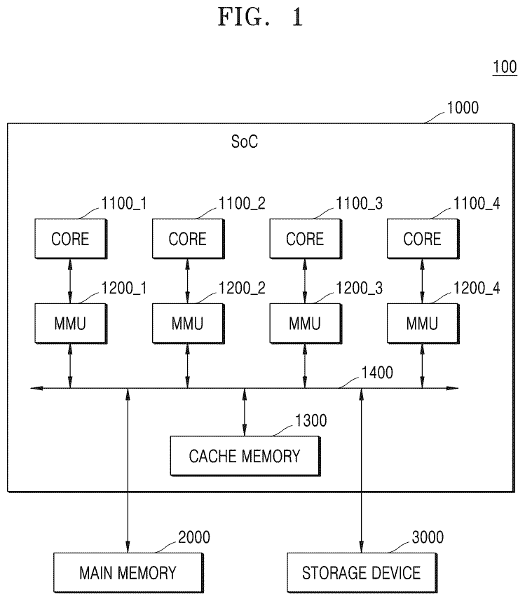

FIG. 1 is a block diagram illustrating an electronic apparatus according to an embodiment.

FIG. 1 illustrates a block diagram of an electronic apparatus according to an embodiment. An electronic apparatus 100 may include a system-on-chip (SoC) 1000, a main memory 2000, and a storage device 3000. The electronic apparatus 100 may also be referred to as an electronic system. For example, the electronic apparatus 100 may be a desktop computer, a laptop computer, a workstation, a server, a mobile device, or the like. In some embodiments, the SoC 1000 may be an application processor (AP).

The SoC 1000 may control an overall operation of the electronic apparatus 100. The SoC 1000 may include a first core 1100_1, a second core 1100_2, a third core 1100_3, and a fourth core 1100_4 (may also be referred to as a processor or a central processing unit (CPU)) 1100_1 to 1100_4), a first memory management unit (MMU) 1200_1, a second MMU 1200_2, a third MMU 1200_3, and a fourth MMU 1200_4, a cache memory 1300, and a bus 1400. The cores 1100 and/or the MMUs 1200 and/or the cache memory 1300 may be referred to as intellectual properties (IPs) in some contexts. Although not illustrated, the SoC 1000 may further include other intellectual properties (IPs) (e.g., a memory controller and the like).

Each of the first to fourth cores 1100_1 to 1100_4 may execute an instruction corresponding to various software (e.g., an application program, an operating system (OS), and/or a device driver). The number of first to fourth cores 1100_1 to 1100_4 illustrated in FIG. 1 is merely an example, and the SoC 1000 may include one or more homogeneous or heterogeneous core(s).

The first to fourth MMUs 1200_1 to 1200_4 may translate a virtual address, which is used as first to fourth software is executed, into a physical address, which is used in a hardware memory device (e.g., the cache memory 1300 inside the SoC 1000, the main memory 2000 outside the SoC 1000, the storage device 3000 outside the SoC 1000, or the like). The first to fourth MMUs 1200_1 to 1200_4 may manage address translation information for translating between the virtual address and the physical address. Due to the address translation information, the first to fourth MMUs 1200_1 to 1200_4 may enable the application programs to have their own private virtual memory spaces and/or may enable the first to fourth cores 1100_1 to 1100_4 to execute multiple tasks.

In some embodiments, the cache memory 1300 may be connected to each of the first to fourth cores 1100_1 to 1100_4 and may be shared by the first to fourth cores 1100_1 to 1100_4. In some embodiments, the cache memory 1300 may be connected to the first to fourth cores 1100_1 to 1100_4 through the first to fourth MMUs 1200_1 to 1200_4. For example, the cache memory 1300 may be implemented by using a register, a flip-flop, a static random access memory (SRAM), or any combination thereof. The cache memory 1300 may have a higher access speed than the main memory 2000. The cache memory 1300 may store commands, data, addresses, address translation information, and the like related to the first to fourth cores 1100_1 to 1100_4.

The bus 1400 may connect the IPs (e.g., the cores 1100_1 to 1100_4, the cache memory 1300, and the like) inside the SoC 1000 or may provide an access path to the main memory 2000 and the storage device 3000 for the internal IPs of the SoC 1000. In some embodiments, the bus 1400 may be of an Advanced Microcontroller Bus Architecture (AMBA) standard bus type. The bus types of AMBA may include Advanced High-Performance Bus (AHB), Advanced Peripheral Bus (APB), and Advanced extensible Interface (AXI). In some embodiments, the bus 1400 may be of a Parallel Advanced Technology Attachment (PATA), Serial Advanced Technology Attachment (SATA), Small Computer System Interface (SCSI), Serial Attached SCSI (SAS), or Peripheral Component Interconnect-Express (PCI-E) bus type.

The main memory 2000 may communicate with the SoC 1000. The main memory 2000 may provide a larger storage capacity to the first to fourth cores 1100_1 to 1100_4 than the storage capacity of the cache memory 1300. The main memory 2000 may store commands, data, addresses, address translation information, and the like provided from the SoC 1000. For example, in some embodiments, the main memory 2000 may include a dynamic random access memory (DRAM). The main memory 2000 may be referred to as a memory device.

The storage device 3000 may communicate with the SoC 1000 or the main memory 2000. The storage device 3000 may provide a larger storage capacity to the first to fourth cores 1100_1 to 1100_4 than the storage capacity of the main memory 2000. The storage device 3000 may store commands, data, addresses, address translation information, and the like provided from the SoC 1000. For example, the storage device 3000 may include a solid state drive (SSD) or a hard disk drive (HDD).

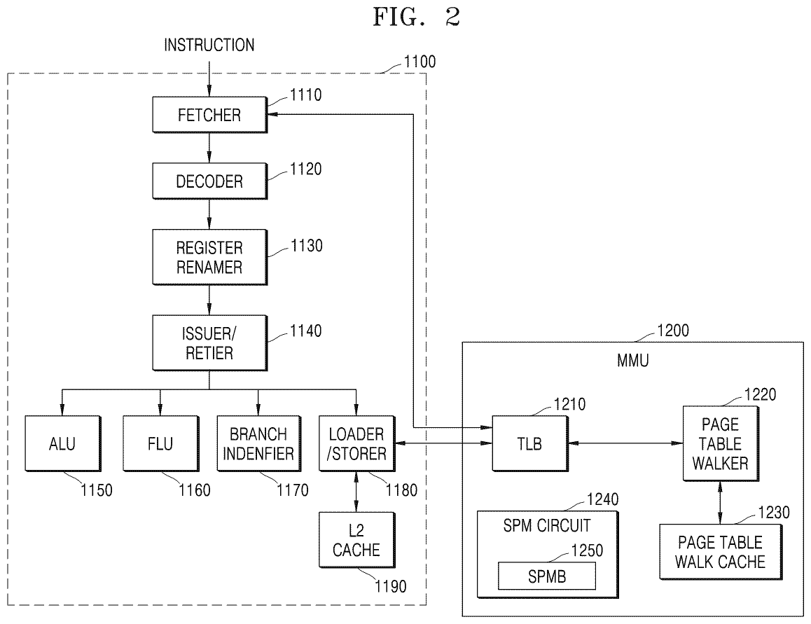

FIG. 2 illustrates a block diagram of one of the first to fourth cores of the SoC of the electronic apparatus of FIG. 1 and an MMU corresponding thereto, according to some embodiments.

A core 1100 may be any one of the first to fourth cores 1100_1 to 1100_4 of the electronic apparatus 100 of FIG. 1. In an embodiment, the core 1100 may include a fetcher 1110, a decoder 1120, a register renamer 1130, an issuer/retirer 1140, an arithmetic logic unit (ALU) 1150, a floating point unit (FPU) 1160, a branch identifier 1170, a loader/storer 1180, and an L2 cache 1190.

The fetcher 1110 may fetch a command by reference to an address of a memory stored in a program counter (not illustrated) tracking a memory address of a command and store the fetched command in a command register (not illustrated). For example, the command may be stored in a memory (e.g., a cache memory (not illustrated) in the core 1100, the cache memory 1300, or the main memory 2000). In some embodiments, the fetcher 1110 may directly generate a virtual address corresponding to the command. The decoder 1120 may decode the command stored in the command register and may determine what command is to be executed. The register renamer 1130 may map logical registers designated by a command to physical registers in the core 1100. The register renamer 1130 may map logical registers designated by consecutive commands to different physical registers to remove the dependency between commands. The issuer/retirer 1140 may control a time when the decoded command is issued (or dispatched) to pipelines and a time when the returned results are retired.

The ALU 1150 may execute an arithmetic operation, a logical operation, a shift operation, or the like based on the dispatched commands. The ALU 1150 may receive operation codes, operands, and the like necessary for an operation from the memory.

The FPU 1160 may execute a floating-point operation.

The branch identifier 1170 may identify that the branch direction of a branch command is predicted in order to improve the flow of the pipelines.

The loader/storer 1180 may execute load and store commands and generate virtual addresses used in load and store operations, and may load data from the L2 cache 1190, the cache memory 1300, and/or the main memory 2000 or store data in the L2 cache 1190, the cache memory 1300, and/or the main memory 2000.

An MMU 1200 may be any one of the first to fourth MMUs 1200_1 to 1200_4 of the electronic apparatus 100 of FIG. 1. In an embodiment, the MMU 1200 may include a translation lookaside buffer (TLB) 1210, a page table walker 1220, a page table walk cache 1230, and a static page management (SPM) circuit 1240.

Address translation information of recently accessed pages may be cached in the TLB 1210. For each memory access performed by the core 1100, the MMU 1200 may identify whether address translation information about a given virtual address is cached in the TLB 1210. The TLB 1210 may store a plurality of TLB entries, each of which is divided into a tag and data. For example, information of a virtual address may be located in the tag, and information of a physical address may be located in the data. For example, in some embodiments, the information of the virtual address may be located in the tag, and information of a physical address corresponding to the virtual address may be located in the data corresponding to the tag. When address translation information about the virtual address is cached in the TLB 1210 (TLB hit), the translation thereof may be immediately used. In other words, when the address translation information about the virtual address is cached in the TLB 1210, the virtual address may be immediately translated into a corresponding physical address using the address translation information cached in the TLB 1210 without using further searching.

When there is no valid address translation information about the virtual address in the TLB 1210 (TLB miss), address translation information about the virtual address may be updated in the TLB 1210 through a page table walk operation of searching through the page tables stored in the cache memory 1300 or the main memory 2000. The page table may be a data structure that stores the mapping between virtual addresses and physical addresses. In other words, when address translation information about the virtual address is not cached in the TLB 1210 (TLB miss), a page table walk operation may be performed to identify the mapping between the virtual address and a physical address.

The SPM circuit 1240 may manage address translation information about certain pages that are selected as static pages. The SPM circuit 1240 may include a static page management buffer (SPMB) 1250. The SPMB 1250 may store address translation information about the static pages. The SPMB 1250 may have the same structure as the TLB 1210. For example, the SPMB 1250 may store a plurality of SPMB entries, each of which is divided into a tag and data. Information of a virtual address of the static page may be located in the tag, and information of a physical address of the static page may be located in the data. For example, in some embodiments, the information of the virtual address may be located in the tag, and the information of a physical address corresponding to the virtual address may be located in the data corresponding to the tag.

When address translation information about the virtual address is cached in the SPMB 1250 (SPMB hit), the SPM circuit 1240 may immediately use the translation thereof. In other words, when the address translation information about the virtual address is cached in the SPMB 1250, the SPM circuit 1240 may immediately translate the virtual address into a corresponding physical address using the address translation information cached in the SPBM 1250 without using further searching. The static page may be a page with relatively high importance. For example, in some embodiments, the static page may refer to a page that is frequently accessed by the OS. In some embodiments, the static page may be a page corresponding to a virtual address whose number of times of access by the core 1100 is a threshold number of times or more. A page corresponding to a virtual address whose number of times of access by the core 1100 is less than the threshold number of times may be referred to as a dynamic page. For example, the static page may correspond to data corresponding to certain software or to data for performing a certain function of the software. In some embodiments, the certain software may be predetermined. In some embodiments, the certain function may be predetermined.

In some embodiments, in response to an address translation request received from the core 1100, the SPMB 1250 and the TLB 1210 may be searched in parallel. When an SPBM hit occurs, the SPM circuit 1240 may stop the core 1100 from accessing the TLB 1210 and/or may stop a page table walk operation of the page table walker 1220. For example, in some embodiments, in response to the SPBM hit, the SPM circuit 1240 may control to stop the core 1110 from searching through the TLB 1210 and/or may control the page table walker 1220 to stop the page table walker 1220 from searching through the page table walk cache 1230. Accordingly, the MMU 1200 may minimize the increase in address translation time by searching the SPMB 1250 and the TLB 1210 in parallel.

In some embodiments, the SPMB 1250 may be searched after the TLB 1210 is searched. For example, the SPM circuit 1240 may search the SPMB 1250 when a TLB miss occurs. When there is no valid address translation information about the virtual address in the SPMB 1250 (SPMB miss), the SPM circuit 1240 may request a page table walk operation of the page table walker 1220. Through the page table walk operation of the page table walker 1220, address translation information about the virtual address may be identified, and the address translation information may be updated in at least one of the SPMB 1250 and the TLB 1210 based on the address translation information identified by the page table walk operation. That is, because the TLB 1210 and the SPMB 1250 are sequentially searched, the SPM circuit 1240 may be implemented in a simple manner without an interruption algorithm used in the case of a parallel search.

The page table walker 1220 may perform a page table walk operation on a virtual address that is not found in the TLB 1210 or the SPMB 1250. The page table walker 1220 may “walk” or search through page tables to find address translation information to translate a virtual address into a physical address. The page table walker 1220 may fetch address translation information about the virtual address from the page tables stored in the cache memory 1300 or the main memory 2000.

The page table walk cache 1230 may cache or store partial or full address translation information of the virtual address. For example, the page tables may be hierarchically structured. The page table walker 1220 may sequentially access or search through the page tables, fetch partial address translation information from the page tables, and store the fetched partial address translation information in the page table walk cache 1230. By searching for the partial address translation information already cached in the page table walk cache 1230, the page table walker 1220 may skip accessing or searching through some page tables stored in the cache memory 1300 or the main memory 2000 and thus accelerate the page table walk.

All components of the core 1100 and MMU 1200 may be implemented in hardware by using analog circuits, digital circuits, logic circuits, clock circuits, flip-flops, registers, and the like.

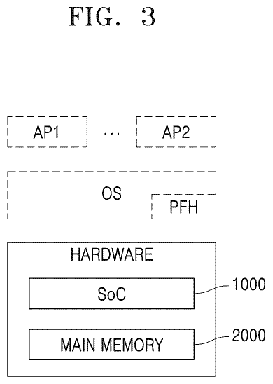

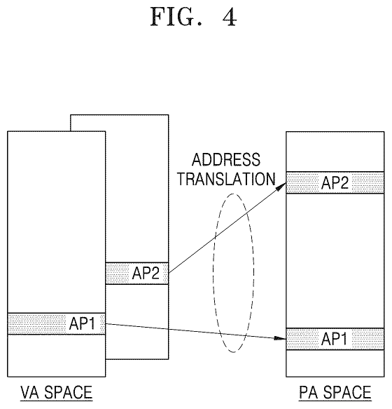

FIG. 3 illustrates application programs and an operating system (OS) executed by the SoC and main memory of the electronic apparatus of FIG. 1, according to some embodiments. FIG. 4 illustrates a mapping between a virtual address space and a physical address space of the application programs of FIG. 3, according to an embodiment. FIG. 3 and FIG. 4 will be described together. FIG. 3 may be described with reference to FIG. 2.

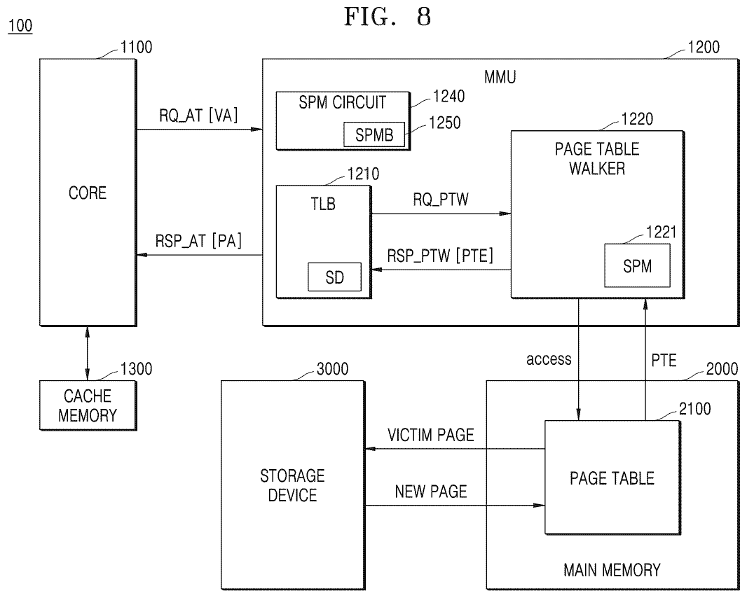

Referring to FIG. 3, the OS may manage hardware including an SoC 1000 and a main memory 2000, and software including one or more application programs AP1 and AP2. The OS may operate such that the one or more application programs AP1 and AP2 are executed on the SoC 1000 and the main memory 2000 by the SoC 1000 and the main memory 2000. The number of application programs AP1 and AP2 illustrated in FIG. 3 is merely an example. Referring to FIG. 3, the OS may include a page fault handler (PFH). The PFH may perform page replacement on a page table in response to a page fault signal output from the MMU 1200. For example, in some embodiments, when a page fault occurs, the PFH may store a page table entry (PTE) including address translation information about a virtual address by allocating a new space in the main memory 2000. In some embodiments, the PFH may replace a victim PTE with a new PTE in the page table. For example, in some embodiments, the PFH may store the victim PTE in the storage device 3000 and store a new PTE for a virtual address in an empty entry. A method of selecting the victim PTE may be described in detail with reference to FIG. 8.

Referring to FIG. 4, the OS may map a virtual address (VA) space of a process according to the execution of a first application program AP1 to a physical address (PA) space. The OS may map a virtual address space of a process according to the execution of a second application program AP2 to a physical address space. By managing the address translation, the OS may efficiently use a limited capacity of a memory (e.g., the main memory 2000) mounted on the hardware.

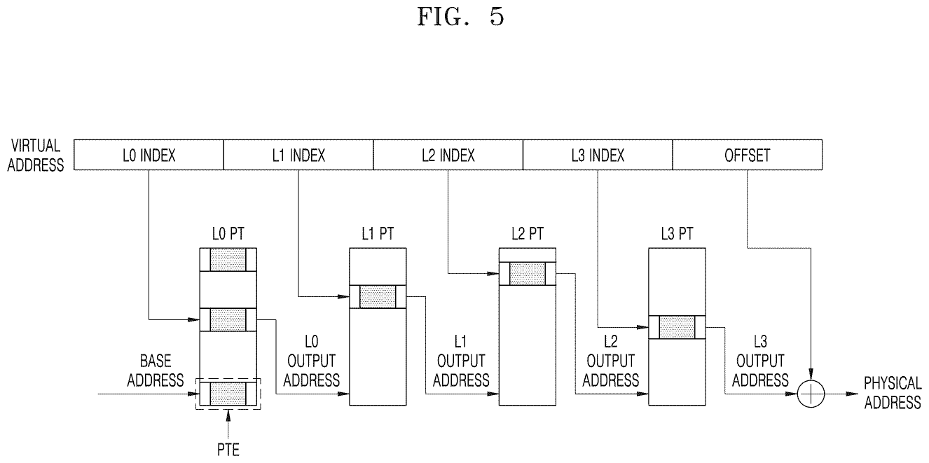

FIG. 5 illustrates a page table walk operation of the page table walker of the MMU of FIG. 2. With reference to FIGS. 2 and 5, the page table walker 1220 may receive an address translation request including a virtual address from the fetcher 1110 or the loader/storer 1180. The virtual address received by the page table walker 1220 may be an address not found in the TLB 1210 (i.e., a TLB miss) or an address not found in the SPMB 1250 (i.e., an SPMB miss). In an embodiment, the multi-bits (e.g., K-bits, where K is a natural number) of the virtual address may be divided into an L0 index, an L1 index, an L2 index, an L3 index, and an offset area. In an embodiment, the indexes of the virtual address may be divided according to levels L0 to L3. In an embodiment, the page tables may also be divided according to levels L0 to L3, or may be hierarchically structured. The number of levels, the number of indexes, and the number of page tables illustrated in FIG. 5 are merely examples. The page table walker 1220 may sequentially search through the page tables hierarchically structured according to the levels L0 to L3. Based on the search order, L0 may be the first level and L3 may be the last level.

First, the page table walker 1220 may search for an entry indicated by the L0 index of the virtual address among the entries of an L0 page table indicated by a base address (i.e., page table entries (PTEs)). The values of base addresses may vary depending on the software (e.g., application, OS, or the like) executed by the core 1100.

The L0 page table may be indexed by the L0 index. Each entry may include attributes and an output address (represented by shading). In an embodiment, the output address may be a physical address. In some embodiments, the attributes may include a permission bit, an access bit, a dirty bit, a secure bit, and the like related to the output address. In an embodiment, each entry may further include a flag bit that distinguishes whether the page is a dynamic page or a static page. The page table walker 1220 may fetch an entry indicated by the L0 index of the virtual address and store or update a portion of information of the entry (i.e., partial address translation information about the L0 index of the virtual address) in the page table walk cache 1230.

The page table walker 1220 may search for an entry indicated by the L1 index of the virtual address among the entries of an L1 page table indicated by an L0 output address of the entry fetched from the L0 page table. The page table walker 1220 may fetch an entry indicated by the L1 index of the virtual address and store a portion of information of the entry (i.e., partial address translation information about the L1 index of the virtual address) in the page table walk cache 1230.

The page table walker 1220 may search for an entry indicated by the L2 index of the virtual address among the entries of an L2 page table indicated by an L1 output address of the descriptor fetched from the L1 page table. The page table walker 1220 may fetch an entry indicated by the L2 index of the virtual address and store a portion of information of the entry (i.e., partial address translation information about the L2 index of the virtual address) in the page table walk cache 1230.

The page table walker 1220 may search for an entry indicated by the L3 index of the virtual address among the entries of an L3 page table indicated by an L2 output address of the entry fetched from the L2 page table. The page table walker 1220 may fetch an entry indicated by the L3 index of the virtual address and store a portion of information of the entry (i.e., partial address translation information about the L3 index of the virtual address) in the page table walk cache 1230. Because the level corresponding to the L3 index and the L3 page table is the final level, the page table walker 1220 may also store the entry in the TLB 1210 or the SPMB 1250.

The MMU 1200 may search for a page indicated by an offset of the virtual address among the pages indicated by the L3 output address of the entry fetched from the L3 page table and may calculate a final physical address (e.g., final physical address=L3 output address+offset). When address translation information between the virtual address and the L3 output address (i.e., final translation) of the L3 page table is cached in the TLB 1210, the MMU 1200 may immediately calculate a final physical address by using the offset and the output address cached in the TLB 1210 and return the final physical address to a circuit that has requested a physical address among the fetcher 1110 or the loader/storer 1180.

When address translation information between the virtual address and the L3 output address (i.e., final translation) of the L3 page table is cached in the SPMB 1250, the SPM circuit 1240 may immediately calculate a final physical address by using the offset and the output address cached in the SPMB 1250 and return the final physical address to a circuit that has requested a physical address among the fetcher 1110 or the loader/storer 1180. The final physical address provided to the fetcher 1110 or the loader/storer 1180 may be included in an address translation response.

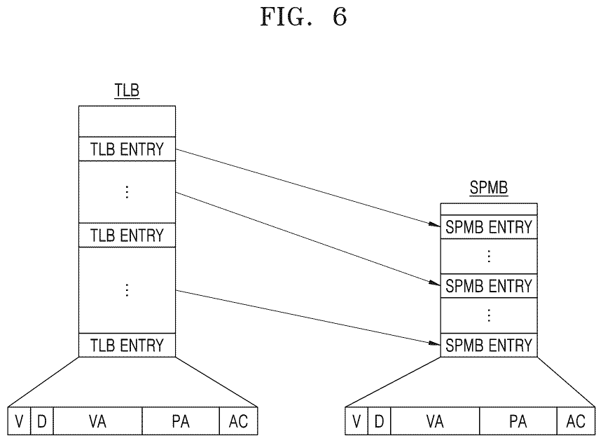

FIG. 6 is a diagram illustrating a translation lookaside buffer (TLB) and a static page management buffer (SPMB), according to some embodiments.

Referring to FIG. 6, the TLB may include a plurality of TLB entries.

Each TLB entry may include a valid field V, a dirty field D, a virtual address field VA corresponding to a tag, a physical address field PA corresponding to data, and an access count field AC. In an embodiment, the data may correspond to the tag for the entry. The type and number of fields included in the TLB entry are not limited to the type and number of fields illustrated in FIG. 6.

The valid field V may indicate the validity of the TLB entry. When a page corresponding to the virtual address is stored in a physical memory (e.g., the cache memory 1300, the main memory 2000, the storage device 3000, or the like), the valid field may indicate valid; otherwise, the valid field may indicate invalid.

The dirty field D may indicate whether the page is writable or only readable.

The virtual address field VA may store a virtual address, and the physical address field PA may store a physical address corresponding to the virtual address.

The access count field AC may indicate a number of times the processor (e.g., the core) has accessed the TLB entry. For example, when the processor accesses the TLB entry through a virtual address, the value of the access count field AC may increase.

The TLB may store a TLB entry for a static page and a dynamic page.

The SPMB may store a TLB entry corresponding to the static page as an SPMB entry. That is, among the TLB entries, a TLB entry corresponding to a static page may be stored in the SPMB. For example, a TLB entry that has a value of the access count field AC that is greater than or equal to a reference value may be determined as a TLB entry for a static page and may be stored in the SPMB.

In some embodiments, among the TLB entries, a TLB entry that has a value of the access count field AC that is greater than or equal to a reference value may be deleted. Thus, address translation information about a dynamic page may be stored in the TLB, and address translation information about a static page may be stored in the SPMB.

In some embodiments, the TLB entries may include both a TLB entry having an access count field (AC) value greater than or equal to a reference value and a TLB entry having an access count field (AC) value less than the reference value. Thus, both the address translation information about the dynamic page and the address translation information about the static page may be stored in the TLB, and the address translation information about the static page may be stored in the SPMB. In some embodiments, both the address translation information about the dynamic page and the address translation information about the static page may be stored in the TLB, and only the address translation information about the static page may be stored in the SPMB.

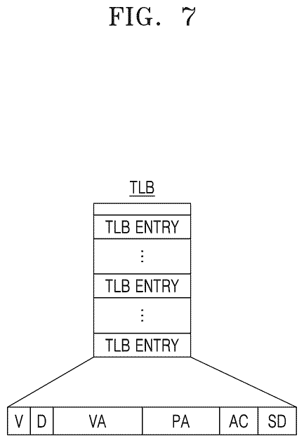

FIG. 7 is a diagram illustrating a TLB according to an embodiment.

Referring to FIG. 7, unlike in the TLB of FIG. 6, each TLB entry may further include a static/dynamic page field SD. The static/dynamic page field SD may be referred to as a static/dynamic page flag.

The static/dynamic page field SD of the TLB entry may indicate whether a page indicated by the TLB entry is a dynamic page or a static page.

In some embodiments, in the case of the TLB entry for data of certain software, the value of the static/dynamic page field SD may indicate a static page. Here, the certain software may be predetermined. In some embodiments, the value of the static/dynamic page field SD may be determined based on the value of the access count field AC. For example, in the case of the TLB entry having a value of the access count field AC that is greater than or equal to a reference value, the value of the static/dynamic page field SD may indicate a static page, and in the case of the TLB entry having a value of the access count field AC that is less than the reference value, the value of the static/dynamic page field SD may indicate a dynamic page.

As illustrated in FIG. 7, when the static/dynamic page field SD is included in the TLB entry, the static page and the dynamic page may be distinguished even without separately managing the SPMB 1250.

FIG. 8 is a diagram illustrating an operation of an electronic apparatus according to an embodiment. Redundant descriptions with those given above with reference to FIGS. 1 to 7 may be omitted for conciseness.

Referring to FIG. 8, the core 1100 may provide an address translation request RQ_AT[VA] including a virtual address VA to the MMU 1200.

In some embodiments, the MMU 1200 may search the TLB 1210 and the SPMB 1250 in parallel. In some embodiments, the MMU 1200 may search the TLB 1210 and the SPM circuit 1240 may search the SPMB 1250 in parallel. In some embodiments, the SPM circuit 1240 may search the SPMB 1250 in response to the address translation request RQ_AT[VA] and, when address translation information corresponding to the virtual address VA is included in the SPMB 1250 (SPMB hit), may generate an address translation response RST_AT[PA] including a physical address PA based on the address translation information included in the SPMB 1250 and provide the address translation response RST_AT[PA] to the core 1100. In an embodiment, the SPM circuit 1240 may stop the access to the TLB 1210 by the core 1100 and/or may stop a page table walk operation. For example, in an embodiment, under the control by the SPM circuit 1240, the MMU 1200 may stop an operation of searching the TLB 1210. That is, in an embodiment, the SPM circuit 1240 may control the MMU 1200 to stop the operation of searching the TLB 1210.

When address translation information corresponding to the virtual address VA is not included in the SPMB 1250 (SPMB miss), the SPM circuit 1240 may wait for a next request. In an embodiment, the SPM circuit 1240 may wait for the next request and not control the MMU 1200 to stop the operation of searching the TLB 1210.

When a TLB hit occurs, the MMU 1200 may generate an address translation response RSP_AT[PA] based on the address translation information of the TLB 1210.

When a TLB miss occurs, the TLB 1210 may provide a page table walk request RQ_PTW to the page table walker 1220. The page table walker 1220 may perform a page table walk operation by accessing a page table 2100 of the main memory 2000.

When address translation information corresponding to the virtual address VA is included in the page table 2100 (PT hit), the page table walker 1220 may fetch a page table entry PTE. The page table walker 1220 may provide a page table walk response RSP_PTW[PTE] including the page table entry PTE to the TLB 1210, and the TLB 1210 may update the TLB entry based on the page table walk response RSP_PTW[PTE].

When address translation information corresponding to the virtual address VA is not included in the page table 2100 (PT miss), the page table walker 1220 may generate a page fault signal. When the page fault signal is generated, the OS executed by the core 1100 may call the PFH. The PFH may update the address translation information corresponding to the virtual address VA in the page table 2100. In an embodiment, the PFH may select a victim page in the page table 2100 and replace the victim page with a new page. The PFH may store address translation information about the victim page in the storage device 3000 and store address translation information about the new page corresponding to the virtual address VA from the storage device 3000 in the page table 2100.

When selecting the victim page, the PFH may set the priority of a static page to be lower than the priority of a dynamic page. For example, because the page table entry PTE may include a flag field distinguishing between a static page and a dynamic page, the PFH may refer to the flag field to replace an entry corresponding to the dynamic page in preference to an entry corresponding to the static page. Because the static page corresponds to high-importance data and software, the speed of the system may be improved by maintaining the static page in the page table for a long time.

When the page table 2100 is updated, the page table walker 1220 may obtain address translation information corresponding to the virtual address VA from the page table 2100 through a page table walk operation and provide a page table walk response RSP_PTW[PTE] including the virtual address VA to the TLB 1210.

In some embodiments, the MMU 1200 may sequentially search the TLB 1210 and the SPMB 1250. In an embodiment, the TLB 1210 may be first searched, and when a TLB miss occurs, the SPMB 1250 may be searched by the SPM circuit 1240. In some embodiments, the SPMB 1250 may be searched by the SPM circuit 1240 only when the TLB miss occurs. When an SPMB miss occurs, a page table walk operation of the page table walker 1220 may be performed, and the TLB 1210 may be updated by the PTE obtained by the page table walker 1220. In this case, the TLB 1210 may store only the address translation information about the dynamic page, and the SPMB 1250 may store only the address translation information about the static page.

In some embodiments, the MMU 1200 may sequentially search the SPMB 1250 and the TLB 1210. In an embodiment, the SPMB 1250 may be first searched by the SPM circuit 1240, and when an SPMB miss occurs, the TLB 1210 may be searched. In some embodiments, the TLB 1210 may be searched only when the SPMB miss occurs. When a TLB miss occurs, a page table walk operation of the page table walker 1220 may be performed, and the TLB 1210 may be updated by the PTE obtained by the page table walker 1220. In this case, the TLB 1210 may store only the address translation information about the dynamic page or may store both the address translation information about the dynamic page and the address translation information about the static page, and the SPMB 1250 may store only the address translation information about the static page.

When the TLB 1210 is updated, the TLB entry may be replaced. In an embodiment, a victim TLB entry among the TLB entries may be removed from the TLB 1210, and a new TLB entry may be stored in the TLB 1210. For example, the MMU 1200 may replace the TLB entry corresponding to the dynamic page in preference to the TLB entry corresponding to the static page. The TLB entry of the TLB 1210 may include the static/dynamic page field SD described above with reference to FIG. 7. For example, the MMU 1200 may select one of the TLB entries corresponding to a dynamic page as a victim TLB entry. The MMU 1200 may distinguish between a TLB entry for the static page and a TLB entry for the dynamic page based on the static/dynamic page field SD. Because the static page corresponds to high-importance data and software, the speed of the system may be improved by maintaining the static page in the page table for a long time.

In some embodiments, the MMU 1200 may search only the TLB 1210. In this case, the TLB entry of the TLB 1210 may include the static/dynamic page field SD described above with reference to FIG. 7. The TLB 1210 may include both the address translation information about the static page and the address translation information about the dynamic page. In the event of a TLB miss and a page fault, the update of the page table 2100 and the update of the TLB 1210 may be performed. When selecting a victim PTE of the page table 2100 and a victim TLB entry of the TLB 1210, an entry including address translation information about a dynamic page may be selected as a victim entry in preference to an entry including address translation information about a static page.

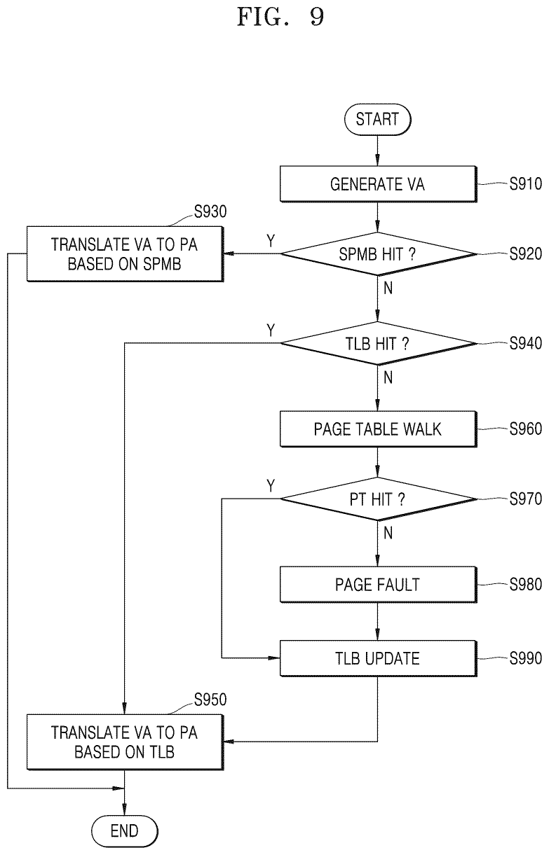

FIG. 9 is a flowchart illustrating an operating method of an SoC according to an embodiment. FIG. 9 may be described with reference to FIGS. 2 and 8.

Referring to FIG. 9, the fetcher 1110 and/or the loader/storer 1180 may generate a virtual address VA (S910).

The MMU 1200 may determine whether there is an SPMB hit (S920). For example, the SM circuit 1240 of the MMU 1200 may search the SPMB 1250 for an entry corresponding to the virtual address VA. When address translation information corresponding to the virtual address VA is included in the SPMB 1250 (SPMB hit) (S920=Y), the MMU 1200 may translate the virtual address VA into a physical address PA based on the SPMB 1250 (S930).

When address translation information corresponding to the virtual address VA is not included in the SPMB 1250 (SPMB miss) (S920=N), the MMU 1200 may determine whether there is a TLB hit (S940). For example, the MMU 1200 may search the TLB 1210 for an entry corresponding to the virtual address VA. When address translation information corresponding to the virtual address VA is included in the TLB 1210 (TLB hit) (S940=Y), the MMU 1200 may translate the virtual address VA into a physical address PA based on the TLB 1210 (S950).

When address translation information corresponding to the virtual address VA is not included in the TLB 1210 (TLB miss) (S940=N), the page table walker 1220 may perform a page table walk operation (S960).

The page table walker 1220 may determine whether there is a page table hit (PT hit) (S970). When address translation information corresponding to the virtual address VA is included in the page table 2100 (PT hit) (S970=Y), the page table walker 1220 may update the TLB 1210 by providing a page table entry PTE corresponding to the virtual address VA to the TLB 1210 (S990).

When address translation information corresponding to the virtual address VA is not included in the page table 2100 (PT miss) (S970=N), the page table walker 1220 may generate a page fault signal (S980).

The PFH may be called by the page fault signal. The PFH may update the address translation information corresponding to the virtual address VA in the page table 2100. In an embodiment, the PFH may select a victim page in the page table 2100 and replace the victim page with a new page. The PFH may store address translation information about the victim page in the storage device 3000 and may store address translation information about the new page corresponding to the virtual address VA from the storage device 3000 in the page table 2100.

When selecting the victim page, the PFH may set the priority of a static page to be lower than the priority of a dynamic page. For example, because the page table entry PTE may include a flag field distinguishing between a static page and a dynamic page, the PFH may refer to the flag field to replace an entry corresponding to the dynamic page in preference to an entry corresponding to the static page. Because the static page corresponds to high-importance data and software, the speed of the system may be improved by maintaining the static page in the page table for a long time.

When the page table is updated, the page table walker 1220 may perform a TLB update (S990).

When the TLB 1210 is updated, the MMU 1200 may translate the virtual address VA into a physical address PA based on the TLB 1210 (S950).

According to an embodiment, the access speed to the static page may be improved by preferentially searching the SPMB 1250. Furthermore, when replacing the page entry, the system speed may be improved by lowering the replacement priority for the static page.

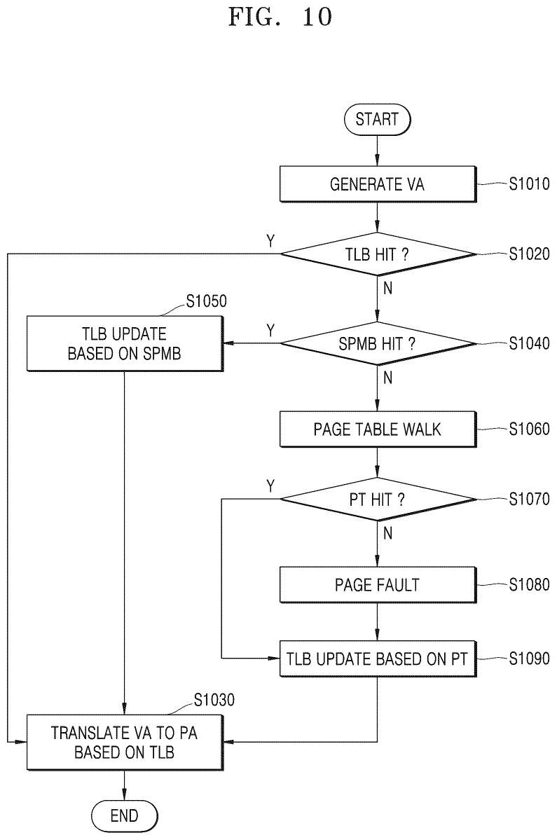

FIG. 10 is a flowchart illustrating an operating method of an SoC according to an embodiment. FIG. 10 may be described with reference to FIGS. 2 and 8.

In the example of FIG. 10, the TLB 1210 may store address translation information about a static page as well as address translation information about a dynamic page.

Referring to FIG. 10, the fetcher 1110 and/or the loader/storer 1180 may generate a virtual address VA (S1010).

The MMU 1200 may determine whether there is a TLB hit (S1020). For example, the MMU 1200 may search the TLB 1210 for an entry corresponding to the virtual address VA. When address translation information corresponding to the virtual address VA is included in the TLB 1210 (TLB hit) (S1020=Y), the MMU 1200 may translate the virtual address VA into a physical address PA based on the TLB 1210 (S1030).

When address translation information corresponding to the virtual address VA is not included in the TLB 1210 (TLB miss) (S1020=N), the MMU 1200 may determine whether there is a SPMB hit (S1040). For example, the SM circuit 1240 of the MMU 1200 may search the SPMB 1250 for an entry corresponding to the virtual address VA. When address translation information corresponding to the virtual address VA is included in the SPMB 1250 (SPMB hit) (S1040=Y), the MMU 1200 may update the TLB 1210 based on the SPMB 1250 (S1050). When the TLB 1210 is updated, the TLB entry may be replaced. In an embodiment, a victim TLB entry among the TLB entries may be removed from the TLB 1210, and a new TLB entry may be stored in the TLB 1210. For example, the MMU 1200 may replace the TLB entry corresponding to the dynamic page in preference to the TLB entry corresponding to the static page. The TLB entry of the TLB 1210 may include the static/dynamic page field SD described above with reference to FIG. 7. For example, the MMU 1200 may select one of the TLB entries corresponding to a dynamic page as a victim TLB entry. The MMU 1200 may distinguish between a TLB entry for the static page and a TLB entry for the dynamic page based on the static/dynamic page field SD. Because the static page corresponds to high-importance data and software, the speed of the system may be improved by maintaining the static page in the page table for a long time.

The MMU 1200 may translate the virtual address VA into a physical address PA based on the updated TLB 1210 (S1030).

When address translation information corresponding to the virtual address VA is not included in the SPMB 1250 (SPMB miss) (S1040=N), the page table walker 1220 may perform a page table walk operation (S1060).

The page table walker 1220 may determine whether there is a page table hit (PT hit) (S1070). When address translation information corresponding to the virtual address VA is included in the page table 2100 (PT hit) (S1070=Y), the page table walker 1220 may update the TLB 1210 by providing a page table entry PTE corresponding to the virtual address VA to the TLB 1210 (S1090).

When address translation information corresponding to the virtual address VA is not included in the page table 2100 (PT miss) (S1070=N), the page table walker 1220 may generate a page fault signal (S1080).

The PFH may be called by the page fault signal. The PFH may update the address translation information corresponding to the virtual address VA in the page table 2100. In an embodiment, the PFH may select a victim page in the page table 2100 and replace the victim page with a new page. The PFH may store address translation information about the victim page in the storage device 3000 and may store address translation information about the new page corresponding to the virtual address VA from the storage device 3000 in the page table 2100.

When selecting the victim page, the PFH may set the priority of a static page to be lower than the priority of a dynamic page. For example, because the page table entry PTE may include a flag field distinguishing between a static page and a dynamic page, the PFH may refer to the flag field to replace an entry corresponding to the dynamic page in preference to an entry corresponding to the static page. Because the static page corresponds to high-importance data and software, the speed of the system may be improved by maintaining the static page in the page table for a long time.

When the page table is updated, the page table walker 1220 may perform a TLB update based on the page table (S1090). When the TLB 1210 is updated, the TLB entry may be replaced based on a new PTE. In an embodiment, a victim TLB entry among the TLB entries may be removed from the TLB 1210, and a new TLB entry corresponding to a new PTE may be stored in the TLB 1210. For example, the MMU 1200 may replace the TLB entry corresponding to the dynamic page in preference to the TLB entry corresponding to the static page. The TLB entry of the TLB 1210 may include the static/dynamic page field SD described above with reference to FIG. 7. For example, the MMU 1200 may select one of the TLB entries corresponding to the dynamic page as a victim TLB entry. The MMU 1200 may distinguish between a TLB entry for the static page and a TLB entry for the dynamic page based on the static/dynamic page field SD. Because the static page corresponds to high-importance data and software, the speed of the system may be improved by maintaining the static page in the page table for a long time.

When the TLB 1210 is updated, the MMU 1200 may translate the virtual address VA into a physical address PA based on the TLB 1210 (S1030).

According to an embodiment, the system speed may be improved because the static page may be updated in the TLB by searching the SPMB before performing a page table walk operation of accessing the main memory 2000. When replacing the PTE or the TLB entry, the system speed may be improved by lowering the replacement priority for the static page.

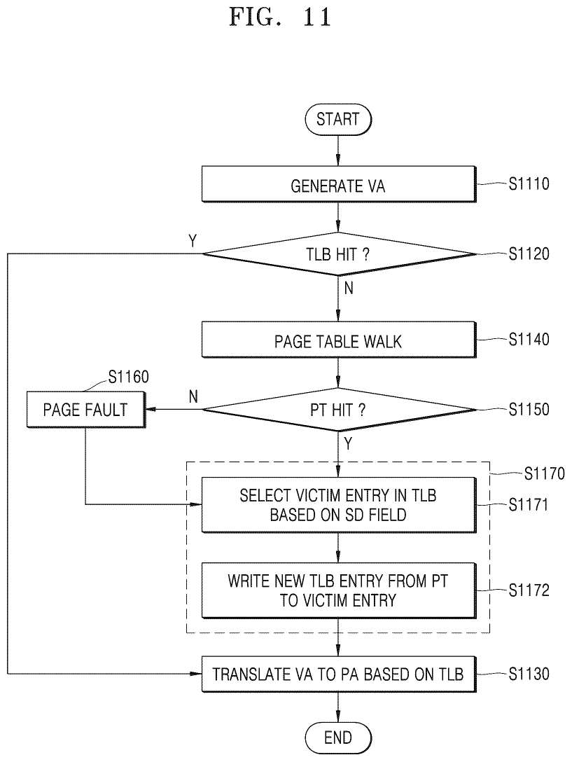

FIG. 11 is a flowchart illustrating an operating method of an SoC according to an embodiment. FIG. 11 may be described with reference to FIGS. 2 and 8.

In the example of FIG. 11, the TLB 1210 may store address translation information about a static page as well as address translation information about a dynamic page.

Referring to FIG. 11, the fetcher 1110 and/or the loader/storer 1180 may generate a virtual address VA (S1110).

The MMU 1200 may determine whether there is a TLB hit (S1120). For example, the MMU 1200 may search the TLB 1210 for an entry corresponding to the virtual address VA. When address translation information corresponding to the virtual address VA is included in the TLB 1210 (TLB hit) (S1120=Y), the MMU 1200 may translate the virtual address VA into a physical address PA based on the TLB 1210 (S1130).

When address translation information corresponding to the virtual address VA is not included in the TLB 1210 (TLB miss) (S1120=N), the page table walker 1220 may perform a page table walk operation (S1140). For example, in an embodiment, the page table walker 1220 may perform the page table walk operation in response to a page table walk request including a TLB miss signal.

The page table walker 1220 may determine whether there is a page table hit (PT hit) (S1150). When address translation information corresponding to the virtual address VA is included in the page table 2100 (PT hit) (S1150=Y), the page table walker 1220 may update the TLB 1210 by providing a page table entry PTE corresponding to the virtual address VA to the TLB 1210 (S1170).

In an embodiment, the MMU 1200 may select a victim entry among the TLB entries of the TLB 1210 based on the static/dynamic page field SD (S1171). For example, the MMU 1200 may select the TLB entry corresponding to the dynamic page as a victim entry in preference to the TLB entry corresponding to the static page. For example, the MMU 1200 may select a victim entry among the TLB entries corresponding to the dynamic page, excluding the TLB entry corresponding to the static page.

The MMU 1200 may write a new TLB entry from the PT to the victim entry (S1172). For example, the MMU 1200 may remove the victim entry from the TLB 1210, generate a new TLB entry based on a PTE corresponding to the virtual address VA among the PTEs of the page table, and write the new TLB entry in an empty entry.

When address translation information corresponding to the virtual address VA is not included in the page table 2100 (PT miss) (S1150=N), the page table walker 1220 may generate a page fault signal (S1160).

The PFH may be called by the page fault signal. The PFH may update the address translation information corresponding to the virtual address VA in the page table 2100. In an embodiment, the PFH may select a victim page in the page table 2100 and replace the victim page with a new page. The PFH may store address translation information about the victim page in the storage device 3000 and may store address translation information about the new page corresponding to the virtual address VA from the storage device 3000 in the page table 2100.

When selecting the victim page, the PFH may set the priority of a static page to be lower than the priority of a dynamic page. For example, because the page table entry PTE may include a flag field distinguishing between a static page and a dynamic page, the PFH may refer to the flag field to replace an entry corresponding to the dynamic page in preference to an entry corresponding to the static page. Because the static page corresponds to high-importance data and software, the speed of the system may be improved by maintaining the static page in the page table for a long time.

When the page table is updated, the MMU 1200 may perform a TLB update based on the page table (S1170).

When the TLB 1210 is updated, the MMU 1200 may translate the virtual address VA into a physical address PA based on the TLB 1210 (S1130).

According to an embodiment, because the TLB entry replacement may be performed by adding only the static/dynamic page field SD to the TLB entry such that the static page is maintained in the TLB entry for a longer time than the dynamic page, the access speed with respect to the static page may be improved without additional hardware.

While various embodiments have been particularly shown and described with reference to the drawings, it will be understood that various changes in form and details may be made therein without departing from the spirit and scope of the following claims.

1. A system-on-chip comprising:
a translation lookaside buffer (TLB) that stores a portion of address translation information for translating between virtual addresses and physical addresses;
at least one core configured to execute an instruction and to access the TLB;
a page table walker configured to perform a page table walk operation of searching a page table that stores the address translation information; and
a static page management (SPM) circuit configured to, when a physical address is obtained from a virtual address included in static address translation information corresponding to a static page among the address translation information, stop access to the TLB by the at least one core or stop the page table walk operation.

2. The system-on-chip of claim 1, wherein, when the physical address is obtained from the static address translation information, the SPM circuit is configured to stop the at least one core from accessing the TLB in response to an address translation request.

3. The system-on-chip of claim 1, wherein, when the physical address is obtained from the static address translation information, the SPM circuit is configured to stop the page table walk operation provided from the TLB.

4. The system-on-chip of claim 1, wherein, when the physical address is obtained from the static address translation information, the SPM circuit is configured to provide address translation information corresponding to the virtual address to the TLB.

5. The system-on-chip of claim 1, wherein, in a page replacement operation of replacing address translation information that is stored in the TLB, a replacement priority of address translation information corresponding to a dynamic page among the address translation information that is stored in the TLB is higher than a replacement priority of address translation information corresponding to the static page.

6. The system-on-chip of claim 1, wherein, in a page replacement operation of replacing address translation information stored in the TLB, at least a portion of address translation information other than address translation information corresponding to the static page among the address translation information that is stored in the TLB is replaced.

7. The system-on-chip of claim 1, wherein the SPM circuit is further configured to store, as the static address translation information, address translation information about a virtual address accessed a threshold number of times or more, among the address translation information.

8. The system-on-chip of claim 1, wherein the SPM circuit is further configured to store, as the static address translation information, address translation information corresponding to a virtual address of data for performing a certain function.

9. The system-on-chip of claim 1, wherein the TLB further stores information distinguishing between the static address translation information and dynamic address translation information,
wherein the static address translation information corresponds to the static page, and the dynamic address translation information corresponds to a dynamic page.

10. The system-on-chip of claim 1, wherein the TLB further stores, for each virtual address in the address translation information stored in the TLB, information about a number of times the at least one core accesses the virtual address.

11. An operating method of a system-on-chip, the operating method comprising:
starting a first search operation of searching a translation lookaside buffer (TLB) that stores address translation information corresponding to a static page and a dynamic page, the address translation information being for translating between virtual addresses and physical addresses;
starting a second search operation of searching a static page management buffer that stores static address translation information corresponding to the static page; and
obtaining a physical address corresponding to a virtual address, based on a result of the first search operation or a result of the second search operation,
wherein, in response to the result of the second search operation being received while the first search operation is still being performed, stopping the first search operation.

12. The operating method of claim 11, further comprising, when the static address translation information includes an entry corresponding to the virtual address, copying the entry from the static page management buffer into the TLB.

13. The operating method of claim 11, further comprising:
starting a page table walk operation of searching a page table that stores address translation information, and
based on the result of the first search operation being obtained, stopping the page table walk operation.

14. The operating method of claim 11, further comprising, in a page replacement operation of replacing the address translation information stored in the TLB, replacing address translation information corresponding to the dynamic page in preference to address translation information corresponding to the static page.

15. The operating method of claim 11, wherein the address translation information corresponding to the static page comprises address translation information corresponding to a virtual address accessed a threshold number of times or more.

16. The operating method of claim 11, further comprising storing, in the TLB, information distinguishing between address translation information corresponding to the static page and address translation information corresponding to the dynamic page.

17. The operating method of claim 11, further comprising storing, in the TLB, information about a number of times a core of the at least one core accesses the address translation information.

18. An operating method of a system-on-chip, the operating method comprising:
performing a first search operation of searching a translation lookaside buffer (TLB) that stores address translation information for a dynamic page and a static page, the address translation information being for translating between virtual addresses and physical addresses;
performing a second search operation of searching a page table that is stored in a memory device, based on a result of the first search operation; and
replacing address translation information for the dynamic page in preference to replacing address translation information for the static page, in at least one of the TLB and the page table, based on the result of the first search operation and a result of the second search operation.

19. The operating method of claim 18, wherein the address translation information for the dynamic page comprises address translation information about a virtual address accessed less than a threshold number of times by a core, and
the address translation information for the static page comprises address translation information about a virtual address accessed the threshold number of times or more by the core.

20. The operating method of claim 18. wherein the address translation information for the static page comprises address translation information corresponding to a virtual address of data of a certain type.

21. (canceled)
